(19) United States
(12) Patent Application Publication
(10) Pub. No.: US 2006/0026650 A1
(43) Pub. Date: Feb. 2, 2006

(54) Apparatus and method for detecting external antenna in a mobile terminal supporting digital multimedia broadcasting service

(75) Inventors: Tao-Il Kim, Yongin-si (KR); In-Ki Kim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/191,716

(22) Filed: Jul. 28, 2005

(30) Foreign Application Priority Data
Jul. 30, 2004 (KR) 2004-60289
Jun. 30, 2005 (KR) 2005-58544

(51) Int. Cl. H04N 7/16; H04N 7/173; H04Q 7/20

(52) U.S. Cl. 725/62; 725/100; 455/424

(57) ABSTRACT

An external antenna detection apparatus in a mobile terminal for receiving a satellite digital multimedia broadcasting (DMB) service. The external antenna detection apparatus includes at least one built-in antenna for receiving a gap filler signal; a detachable external antenna for receiving a satellite signal; a radio frequency (RF) module for transmitting/receiving a radio signal; an antenna connector for switching a reception path to one of a first path connected to the built-in antenna and a second path connected to the external antenna; a connector coupler for selecting the reception path according to whether the connector coupler is coupled to the antenna connector; and a baseband processor for processing a signal received through the first or second path via the RF module, monitoring a change in voltage-level signal, and detecting attachment and detachment of the external antenna according to the monitoring result.

### PRIORITY

This application claims priority under 35 U.S.C. § 119 to an application entitled “Apparatus and Method for Detecting External Antenna in a Mobile Terminal Supporting Digital Multimedia Broadcasting Service” filed in the Korean Intellectual Property Office on Jul. 30, 2004 and assigned Serial No. 2004-60289, and an application entitled “Apparatus and Method for Detecting External Antenna in a Mobile Terminal Supporting Digital Multimedia Broadcasting Service” filed in the Korean Intellectual Property Office on Jun. 30, 2005 and assigned Serial No. 2005-58544, the contents of both of which are incorporated herein by reference.

### BACKGROUND OF THE INVENTION

1. Field of the Invention

The present invention relates generally to an apparatus and method for detecting an external antenna in a mobile terminal, and in particular, to an apparatus and method for detecting an external antenna in a mobile terminal supporting Digital Multimedia Broadcasting (DMB) service.

2. Description of the Related Art

In general, digital broadcasting technology refers to the technology that provides users with high-quality audio/video services, replacing the conventional analog broadcasting technology. The digital broadcasting technology has evolved into terrestrial broadcasting technology and satellite broadcasting technology. While broadcast signals are received via terrestrial repeaters in the terrestrial broadcasting technology, broadcast signals are received via a satellite repeater in the satellite broadcasting technology. DMB technology is one of the typical digital broadcasting technologies. The DMB technology is also classified into terrestrial DMB technology and satellite DMB technology. Likewise, while the terrestrial DMB technology provides broadcasting service to users via terrestrial repeaters, the satellite DMB technology provides broadcasting service to users via a satellite repeater.

A detailed description of the satellite DMB technology will now be made with reference to FIG. 1.

Referring to FIG. 1, a satellite DMB broadcasting center 100 on the earth transmits broadcast signals to a DMB satellite 106 through a Ku-band (12 GHz-13 GHz) by Time Division Multiplexing (TDM) 102 and Code Division Multiplexing (CDM) 104. The DMB satellite 106 receives the broadcast signals 102 and 104, and transmits the received signals 102 and 104 to receiving terminals 116 or a gap filler 108, which is a terrestrial repeater, on the earth.

The DMB satellite 106 converts the received signals into S-band CDM signals 112 of 2-3 GHz and Ku-band TDM signals 110 before transmission to the earth. The DMB satellite 106 transmits the broadcast signals to the gap filler 108 in order to transmit the broadcast signals up to the unserviceable area, also known as the gap, like a basement. The gap filler 108 converts the received broadcast signals into S-band signals and transmits the S-band signals to terminals in the unserviceable area.

Generally, a mobile terminal supporting satellite DMB service requires at least two antennas, including a lower-sensitivity antenna for receiving gap filler signals and a higher-sensitivity antenna for directly receiving satellite signals. Therefore, to receive the broadcast signals transmitted via two different paths, the satellite DMB receiving terminal 116 has a built-in antenna with a lower sensitivity and an external antenna with a higher sensitivity. Alternatively, the higher-sensitivity antenna can be embedded in the receiving terminal 116.

However, if both of the two antennas are embedded in the receiving terminal 116, the receiving terminal 116 increases in size and decreases in antenna performance. To solve this problem, a detachable external antenna for receiving the satellite signals has been proposed. In this case, however, there is a need for optimized hardware and software for detecting attachment/detachment of the external antenna and changing a reception path of the broadcast signals according thereto.

### SUMMARY OF THE INVENTION

It is, therefore, an object of the present invention to provide an apparatus and method for detecting an external antenna of a mobile terminal to efficiently receive broadcast service in a wireless communication system supporting satellite Digital Multimedia Broadcasting (DMB) service.

It is another object of the present invention to provide an apparatus and method for simply detecting attachment/detachment of an external antenna used for receiving satellite signals in a wireless communication system supporting satellite DMB service.

It is further another object of the present invention to provide an apparatus and method for detecting attachment/detachment of an external antenna used for receiving satellite signals in an area where satellite DMB service is unavailable, and providing an appropriate message to a user.

According to one aspect of the present invention, there is provided an external antenna detection apparatus in a mobile terminal for receiving a satellite digital multimedia broadcasting (DMB) service. The external antenna detection apparatus includes at least one built-in antenna for receiving a gap filler signal; a detachable external antenna for receiving a satellite signal; a radio frequency (RF) module for transmitting and receiving a radio signal; an antenna connector for switching a reception path to one of a first path connected to the built-in antenna and a second path connected to the external antenna; a connector coupler fixed to the external antenna, for selecting the reception path according to whether the connector coupler is coupled to the antenna connector; and a baseband processor for processing a signal received through the first or second path via the RF module, monitoring a change in a voltage-level signal caused by coupling/decoupling between the connector coupler and the antenna connector, and detecting attachment/detachment of the external antenna according to the monitoring result.

According to another aspect of the present invention, there is provided an external antenna detection method in a mobile terminal including at least one built-in antenna for receiving a gap filler signal from a gap filler for repeating a satellite signal transmitted from a digital multimedia broadcasting (DMB) satellite, a detachable external antenna for directly receiving the satellite signal, and a baseband processor for baseband signal processing. The external antenna detection method including the steps of determining by the baseband processor whether a connector coupler to which the external antenna is fixed is coupled to an antenna connector to which the built-in antenna is connected; applying a predetermined voltage-level signal to the baseband processor if the connector coupler is coupled to the antenna connector; and detecting, by the baseband processor, attachment of the external antenna based on the voltage-level signal, and optimizing a reception path to a path passing through the external antenna upon detecting the attachment of the external antenna.

According to further another aspect of the present invention, there is provided an external antenna detection method in a mobile terminal including at least one built-in antenna for receiving a gap filler signal from a gap filler for repeating a satellite signal transmitted from a digital multimedia broadcasting (DMB) satellite, and a detachable external antenna for directly receiving the satellite signal. The external antenna detection method includes the steps of comparing strength of the gap filler signal with a predetermined threshold when a broadcast signal is received using the built-in antenna; determining whether the external antenna is attached, if the strength of the gap filler signal is lower than or equal to the threshold; and outputting a message requesting for attachment of the external antenna if the external antenna is detached.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a network configuration of a satellite DMB system to which the present invention is applicable;

FIG. 2 is a block diagram illustrating an internal structure of an external antenna detection apparatus according to a first embodiment of the present invention;

FIG. 3A is a diagram illustrating circuit structures of the connector coupler and the antenna connector shown in FIG. 2 before they are coupled to each other;

FIG. 3B is a diagram illustrating circuit structures of the connector coupler and the antenna connector shown in FIG. 2 after they are coupled to each other;

FIG. 4 is a flowchart illustrating an external antenna detection method according to the first embodiment of the present invention;

FIG. 5 is a block diagram illustrating an internal structure of an external antenna detection apparatus according to a second embodiment of the present invention;

FIG. 6 is a flowchart illustrating an external antenna detection method according to the second embodiment of the present invention;

FIG. 7 is a block diagram illustrating an internal structure of an external antenna detection apparatus according to a third embodiment of the present invention;

FIG. 8A is a diagram illustrating circuit structures of the connector coupler and the antenna connector shown in FIG. 7 before they are coupled to each other;

FIG. 8B is a diagram illustrating circuit structures of the connector coupler and the antenna connector shown in FIG. 7 after they are coupled to each other;

FIG. 9A is a diagram illustrating an exemplary structure of a pull-up/down resistor unit, given for a description of a voltage level being applied to a third input terminal before the antenna connector is coupled to the connector coupler as shown in FIG. 8A;

FIG. 9B is a diagram illustrating an exemplary structure of a pull-up/down resistor unit, given for a description of a voltage level being applied to a third input terminal after the antenna connector is coupled to the connector coupler as shown in FIG. 8B;

FIG. 10A is a diagram illustrating an alternative exemplary structure of a pull-up/down resistor unit, given for a description of a voltage level being applied to a third input terminal before the antenna connector is coupled to the connector coupler as shown in FIG. 8A; and

FIG. 10B is a diagram illustrating an alternative exemplary structure of a pull-up/down resistor unit, given for a description of a voltage level being applied to a third input terminal after the antenna connector is coupled to the connector coupler as shown in FIG. 8B.

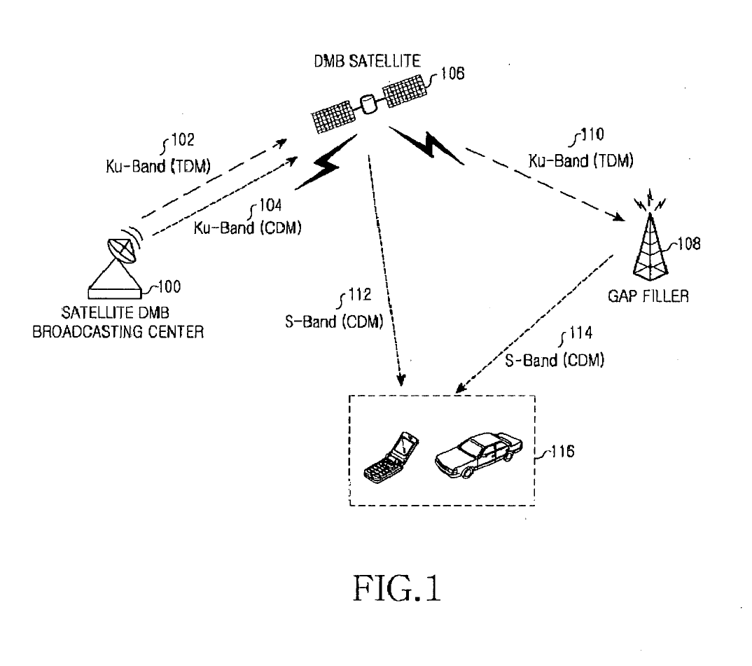

### DETAILED DESCRIPTION OF THE PREFERRED EMBODIMENTS

Several preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for conciseness.

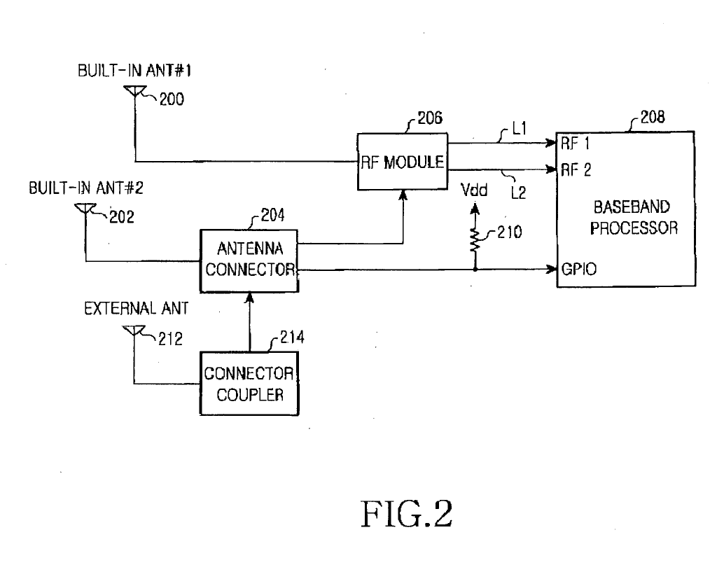

FIG. 2 is a block diagram illustrating an internal structure of an external antenna detection apparatus according to an embodiment of the present invention.

Referring to FIG. 2, a first built-in antenna 200 and a second built-in antenna 202 are internal antennas embedded in a mobile terminal. It is assumed herein that the mobile terminal has at least two antennas to obtain antenna diversity when receiving broadcast signals, by way of example. The first built-in antenna 200 is a dual-band antenna for transmitting/receiving radio signals for a general cellular mobile communication system and/or receiving gap filler signals for satellite DMB service from a gap filler 108, and is fixedly connected to a radio frequency (RF) module 206.

The second built-in antenna 202 is an embedded antenna for receiving gap filler signals from the gap filler 108. When receiving the gap filler signals, the first built-in antenna 200 and the second built-in antenna 202 provide diversity in which reception performance of the mobile terminal is improved in a multipath fading environment. If strength of the gap filler signals transmitted from the gap filler 108 is less than or equal to a predetermined threshold, a detachable external antenna 212 is attached to the mobile terminal so that the mobile terminal can directly receive satellite signals from a DMB satellite 106.

Herein, the external antenna 212 is physically electrically coupled to an antenna connector 204 via a connector coupler 214. The antenna connector 204 selectively switches one of the broadcast signals received via the second built-in antenna 202 and the broadcast signals received via the external antenna 212 to the RF module 206 according to whether it is coupled to the connector coupler 214. Herein, the broadcast signals transmitted via the DMB satellite 106 will be referred to as “satellite signals,” and the broadcast signals transmitted via the gap filler 108 will be referred to as “gap filler signals.”

The antenna connector 204 and the connector coupler 214 constitute a block for switching (selecting) one of a reception path connecting the second built-in antenna 202 to the RF module 206 and a reception path connecting the external antenna 212 to the RF module 206. The antenna connector 204 connects the first and second built-in antennas 200 and 202 to the RF module 206 when it is decoupled from the connector coupler 214, and the antenna connector 204 connects the first built-in antenna 200 and the external antenna 212 to the RF module 206 when it is coupled to the connector coupler 214.

Herein, a path for connecting the first built-in antenna 200 and the second built-in antenna 202 to the RF module 206 to receive gap filler signals therethrough will be referred to as a “first path,” and a path for connecting the external antenna 212 to the RF module 206 to directly receive satellite signals therethrough will be referred to as a “second path.” A detailed description of internal circuit structures of the antenna connector 204 and the connector coupler 214 for the switching operation will be made hereinbelow.

The broadcast signals received via the antenna connector 204 are input to the RF module 206. The RF module 206 includes an RF transmitter for frequency-up-converting and amplifying the signals to be transmitted to a wireless network, and an RF receiver for low-noise-amplifying and frequency-down-converting received signals. When the gap filler signals are received through the first path, the RF module 206 outputs the signals received from the first built-in antenna 200 to a first input terminal RF1 of a baseband processor 208 via a first line L1, and outputs the signals received from the second built-in antenna 202 to a second input terminal RF2 of the baseband processor 208 via a second line L2.

The baseband processor 208 processes the frequency-down-converted baseband signals from the RF module 206, and detects attachment/detachment of the external antenna 212 by sensing a change in the voltage-level signal applied to a third input terminal (or general purpose input/output (GPIO) terminal) according to attachment/detachment of the external antenna 212 (i.e., whether the connector coupler 214 is coupled to the antenna connector 204).

In this embodiment, a pull-up resistor 210 is connected between the antenna connector 204 and the baseband processor 208. As a result, when the connector coupler 214 is decoupled from the antenna connector 204, a high-level signal is applied to the third input terminal GPIO via the pull-up resistor 210, and when the connector coupler 214 is coupled to the antenna connector 204, a low-level signal is applied to the third input terminal GPIO as the pull-up resistor 210 is connected to the internal ground.

Therefore, the baseband processor 208 can detect attachment/detachment of the external antenna 212 by sensing a change in level of the signal applied to the third input terminal GPIO. When the external antenna 212 is attached, the second built-in antenna 202 is cut off from a controller (not shown), preventing unnecessary power consumption.

Although the baseband processor 208 is designed herein such that it detects attachment/detachment of the external antenna 212 by monitoring a change in the voltage-level signal of the pull-up resistor 210, the baseband processor 208 can also be designed such that the antenna connector 204 directly outputs a voltage-level signal according to attachment/detachment of the external antenna 212 and the baseband processor 208 detects the voltage-level signal.

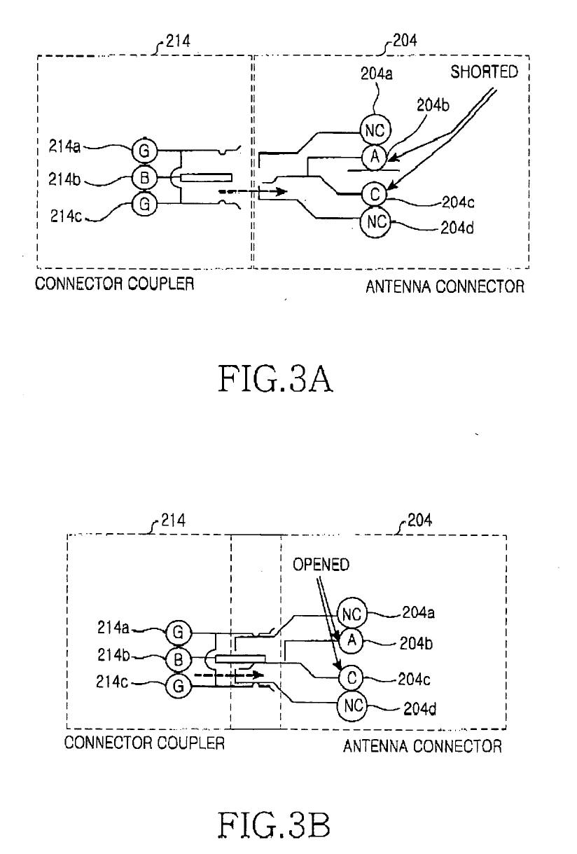

FIGS. 3A and 3B illustrates electrical circuits of the antenna connector and the connector coupler illustrated in FIG. 2 before and after they are coupled to each other, respectively. With reference to FIGS. 3A and 3B, a detailed description of the embodiment of the present invention will be made herein below.

FIG. 3A illustrates circuit structures of the connector coupler 214 and the antenna connector 204 before they are coupled to each other. In the connector coupler 214, reference numerals 214a and 214c represent ground terminals connected to the internal ground (not shown) of the external antenna detection apparatus proposed in the present invention, and reference numeral 214b represents a signal input terminal connected to the external antenna 212.

In the antenna connector 204, reference numerals 204a and 204d represent No Connect (NC) terminals constructed such that they maintain an open state to cut off their connections from other terminals when the antenna connector 204 is decoupled from the connector coupler 214, and they connect an end of the pull-up resistor 210 to the internal ground when the antenna connector 204 is coupled to the connector coupler 214. Reference numeral 204b represents a first connection terminal for connecting the second built-in antenna 202 to the RF module 206 when the antenna connector 204 is decoupled from the connector coupler 214, and reference numeral 204c represents a second connection terminal that is connected to the signal input terminal 214b to connect the external antenna 212 to the RF module 206 when the antenna connector 204 is coupled to the connector coupler 214.

Therefore, as shown in FIG. 3A, before the connector coupler 2i4 is coupled to the antenna connector 204, the second built-in antenna 202 is connected to the RF module 206 via the first connection terminal 204b and the baseband processor 208 detects detachment of the external antenna 212 by sensing a high-level signal being applied thereto through the pull-up resistor 210.

FIG. 3B illustrates circuit structures of the connector coupler 214 and the antenna connector 204 after they are coupled to each other. The signal input terminal 214b of the connector coupler 214 is coupled to the second connection terminal 204c of the antenna connector 204, decoupling from the first connection terminal 204b of the antenna connector 204. In addition, the ground terminals 214a and 214c of the connector coupler 214 are coupled to the NC terminals 204a and 204d of the antenna connector 204, respectively.

Therefore, as shown in FIG. 3B, after the connector coupler 214 is coupled to the antenna connector 204, the external antenna 212 is connected to the RF module 206 via the second connection terminal 204c and the baseband processor 208 detects attachment of the external antenna 212 by sensing a low-level signal being applied thereto through the pull-up resistor 210.

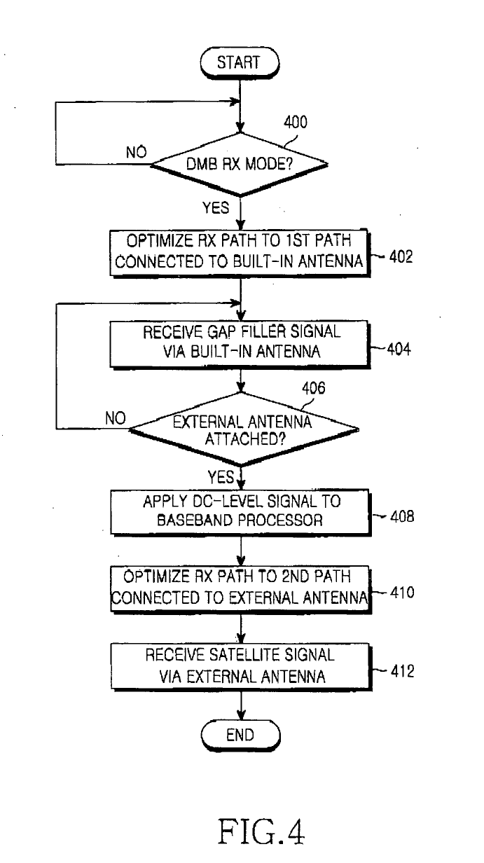

FIG. 4 is a flowchart illustrating an external antenna detection method according to a first embodiment of the present invention. Specifically, FIG. 4 illustrates a process of detecting attachment/detachment of the connector coupler 214 by the baseband processor 208.

A user desiring to receive satellite broadcasting sets a DMB reception mode by performing key manipulation on a mobile terminal. The baseband processor 208 determines in step 400 whether or not the DMB reception mode is set. If the DMB reception mode is set, the baseband processor 208 optimizes a reception path for DMB signals to a first path in which the first built-in antenna 200 and the second built-in antenna 202 in step 402 are used. In step 404, the baseband processor 208 receives gap filler signals provided via the first path set in step 402 (i.e., via the first and second built-in antennas 200 and 202 and the RF module 206).

In step 406, the baseband processor 208 determines if the external antenna 212 is attached by monitoring a change in the voltage-level signal being applied to the third input terminal GPIO thereof. When the external antenna 212 is detached, a high-level signal is applied to the third input terminal GPIO via the pull-up resistor 210, an end of which is connected to the power supply voltage Vdd. When the external antenna 212 is attached, a low-level signal is applied to the third input terminal GPIO as the NC terminals 204a and 204d of the antenna connector 204 are coupled to the other end of the pull-up resistor 210.

If it is determined in step 406 that the external antenna 212 is attached, the baseband processor 208 proceeds to step 408 where it receives a low-level signal via the third input terminal GPIO thereof. However, if it is determined in step 406 that the external antenna 212 is detached, the baseband processor 208 returns to step 404. In step 410, the baseband processor 208, which has detected the attachment of the external antenna 212, optimizes the reception path for broadcast signals to a second path in which the external antenna 212 is used. In step 412, the baseband processor 208 receives satellite signals provided via the second path (i.e., via the external antenna 212 and the RF module 206).

According to the foregoing embodiment, the baseband processor 208 simply detects attachment/detachment of the external antenna 212 by monitoring a variation in the voltage-level signal being applied thereto via the pull-up resistor 210. In this manner, the baseband processor 208 can optimize reception paths for the gap filler signals and satellite signals.

A description will now be made of another embodiment of the present invention in which attachment/detachment of an external antenna is detected and if strength of received broadcast signals is less than or equal to a threshold, a message requesting attachment of the external antenna is provided to the user.

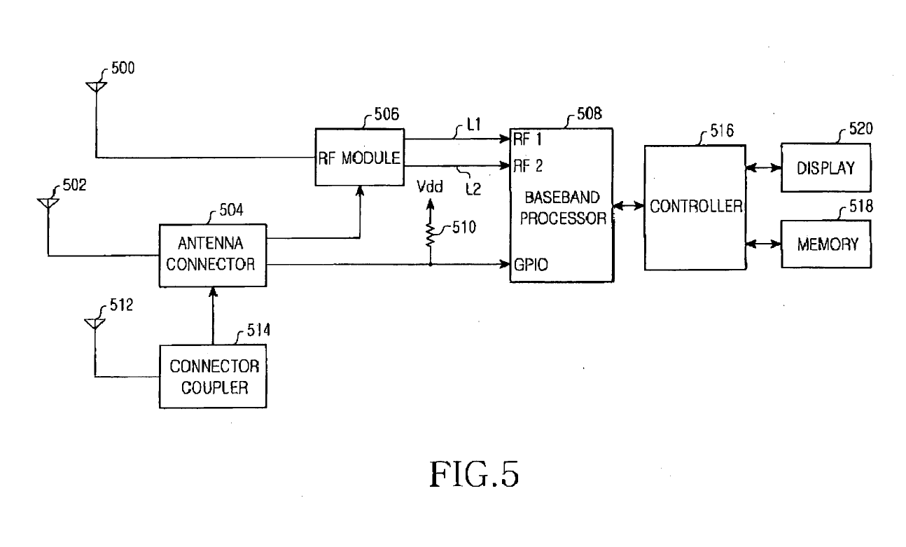

FIG. 5 is a block diagram illustrating an internal structure of an external antenna detection apparatus according to a second embodiment of the present invention. In FIG. 5, because elements 500 through 514 are equivalent in operation to their corresponding elements of FIG. 2, a detailed description thereof will be omitted.

A controller 516 controls the overall operation of a mobile terminal. The controller 516 changes an operation mode of the mobile terminal to a DMB reception mode when the DMB reception mode is selected through manipulation of a key input unit (not shown). When gap filler signals are received through a first path, the controller 516 compares strength of the gap filler signals with a predetermined threshold. If the strength of the gap filler signals is less than the threshold, the controller 516 provides the user with a message requesting attachment of an external antenna 512.

When satellite signals are received through a second path, the controller 516 compares strength of the satellite signals with a predetermined threshold. If the strength of the satellite signals is less than the threshold, the controller 516 provides the user with a message indicating that the user is currently located in an area where satellite DMB service is unavailable.

A memory 518 stores the message requesting attachment of the external antenna, the message indicating the unserviceable area, and the threshold. When outputting the message, the controller 516 determines attachment/detachment of the external antenna 512 using a baseband processor 508 that has sensed attachment/detachment of the external antenna 512. If it is determined that the external antenna 512 is detached, the controller 516 reads a corresponding message from the memory 518, and displays the message on a display 520, or outputs the message through a speaker (not shown).

The memory 518 can be comprised of a Read Only Memory (ROM) and a Random Access Memory (RAM). The memory 518 stores a program for controlling the external antenna detection operation according to an embodiment of the present invention, and a program for performing an operation optimized for each setting depending on the use or nonuse of the built-in and external antennas, determined by the baseband processor 508, according to an embodiment of the present invention.

The display 520 visually displays various signals output from the controller 516. A Liquid Crystal Display (LCD) can be used as the display 520. In this case, the display 520 can include an LCD controller, a memory for storing image data, and an LCD display element. In the case where the LCD is implemented with a touch screen, the display 520 can also serve as an input unit.

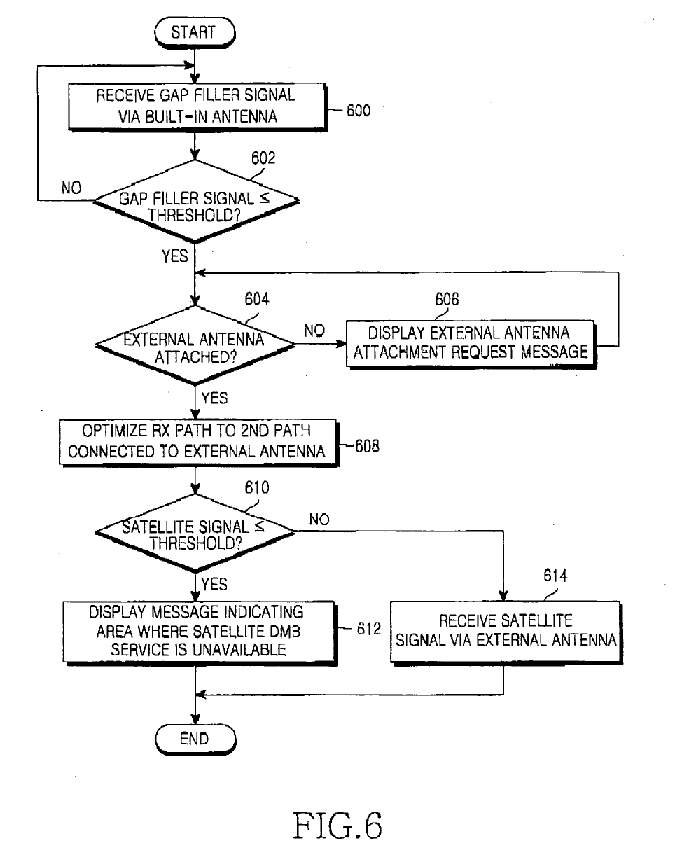

FIG. 6 is a flowchart illustrating an external antenna detection method according to the second embodiment of the present invention. It will be assumed herein that the mobile terminal initially receives broadcast signals using built-in antennas.

In step 600, the mobile terminal receives gap filler signals provided via the gap filler 108 using the first and second built-in antennas 500 and 502. In step 602, the controller 516 compares strength of the gap filler signals with a predetermined threshold every predetermined period. If the strength of the gap filler signals is less than or equal to the threshold, the controller 516 proceeds to step 604. In step 604, the controller 516 determines whether the external antenna 512 is attached (i.e., whether the connector coupler 514 is coupled to the antenna connector 504, using the baseband processor 508).

If it is determined in step 604 that the baseband processor 508 has detected attachment of the external antenna 512, the controller 516 proceeds to step 608 where the baseband processor 508 optimizes a reception path for broadcast signals to the second path connected to the external antenna 512.

However, if it is determined in step 604 that the external antenna 512 is detached, the controller 516 proceeds to step 606 where it reads a message requesting for attachment of the external antenna 512 from the memory 518 and outputs the message to the display 520, and then returns to step 604. In step 604, the process of determining whether the connector coupler 514 is coupled to the antenna connector 504, is performed using the method described with reference to FIGS. 3A and 3B.

In step 608, the baseband processor 508 optimizes the reception path for broadcast signals to the second path. Thereafter, in step 610, the controller 516 compares strength of satellite signals received via the external antenna 512 with a predetermined threshold. If the strength of the satellite signals is less than or equal to the threshold, the controller 516 proceeds to step 612 where it outputs to the display 520 a message indicating an area where the satellite DMB service is unavailable. However, if it is determined in step 610 that the strength of the satellite signals is higher than the threshold, the controller 516 proceeds to step 614 where the baseband processor 508 receives the satellite signals via the second path set in step 608.

The first and second embodiments of the present invention are available only for the antenna connector with NC terminals. With reference to the accompanying drawings, a description will now be made of another embodiment available even for an antenna connector with no NC connector.

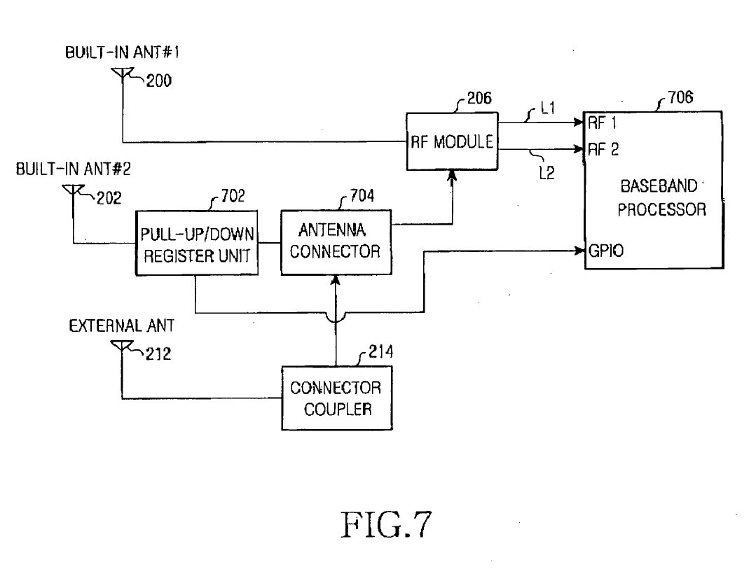

FIG. 7 is a block diagram illustrating an internal structure of an external antenna detection apparatus according to a third embodiment of the present invention.

In FIG. 7, an antenna connector 704 and a connector coupler 214 connect first and second built-in antennas 200 and 202 to the RF module 206 when the external antenna 212 is detached. The antenna connector 704 and the connector coupler 214 connect the first built-in antenna 200 and the external antenna 212 to the RF module 206 when the external antenna 212 is attached.

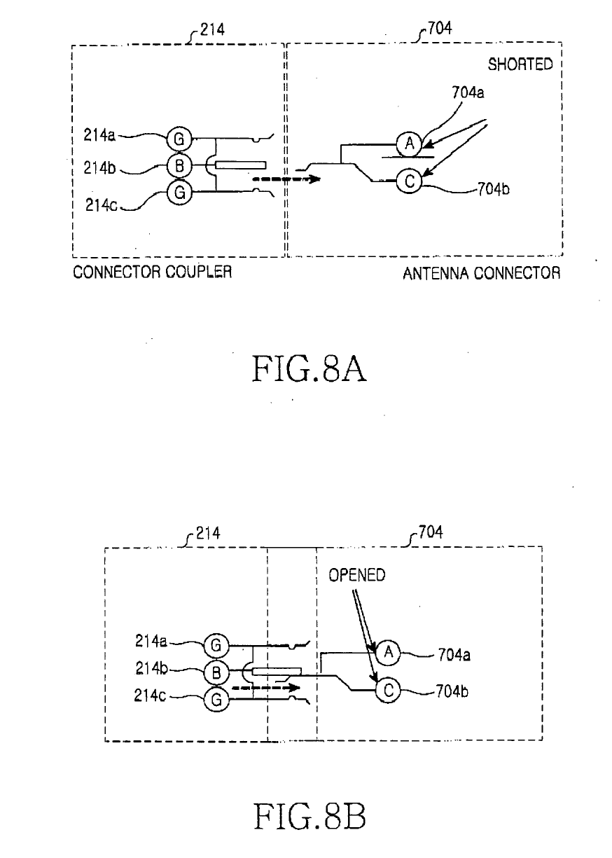

Herein, a path for connecting the first built-in antenna 200 and the second built-in antenna 202 to the RF module 206 to receive gap filler signals therethrough will be referred to as a “first path,” and a path for connecting the external antenna 212 to the RF module 206 to directly receive satellite signals therethrough will be referred to as a “second path.” A detailed description of internal circuit structures of the antenna connector 704 and the connector coupler 214 for the switching operation will be made later with reference to FIGS. 8A and B.

The broadcast signals received through the antenna connector 704 are input to the RF module 206. The RF module 206 includes an RF transmitter for frequency-up-converting and amplifying the signals to be transmitted to a wireless network, and an RF receiver for low-noise-amplifying and frequency-down-converting received signals. When the gap filler signals are received through the first path, the RF module 206 outputs the signals received from the first built-in antenna 200 to a first input terminal RF1 of a baseband processor 706 via a first line L1, and outputs the signals received from the second built-in antenna 202 to a second input terminal RF2 of the baseband processor 706 via a second line L2.

The baseband processor 706 processes the frequency-down-converted baseband signals from the RF module 206, and detects attachment and detachment of the external antenna 212 by monitoring a change in the voltage-level signal applied to a third input terminal GPIO according to attachment/detachment of the external antenna 212 (i.e., according to whether the connector coupler 214 is coupled to the antenna connector 704).

In this embodiment, a pull-up/down resistor unit 702 is connected between the antenna connector 704 and the baseband processor 706. As a result, when the connector coupler 214 is decoupled from the antenna connector 704, a low-level signal is applied to the third input terminal GPIO via the pull-up/down resistor unit 702. When the connector coupler 214 is coupled to the antenna connector 704, a high-level signal is applied to the third input terminal GPIO via the pull-up/down resistor unit 702.

Therefore, the baseband processor 706 can detect attachment and detachment of the external antenna 212 by sensing a change in level of the signal applied to the third input terminal GPIO. When the external antenna 212 is attached, the second built-in antenna 202 is cut off from a controller (not shown), preventing unnecessary power consumption.

FIGS. 8A and 8B are diagrams illustrating electrical circuit structures of the antenna connector and the connector coupler illustrated in FIG. 7 before and after they are coupled to each other, respectively. With reference to FIGS. 8A and 8B, a detailed description of the third embodiment of the present invention will be made herein below.

FIG. 8A illustrates circuit structures of the connector coupler 214 and the antenna connector 704 before they are coupled to each other. In the connector coupler 214, reference numerals 214a and 214c represent ground terminals connected to the internal ground (not shown) of the external antenna detection apparatus proposed in the present invention, and reference numeral 214b represents a signal input terminal connected to the external antenna 212.

In the antenna connector 704, reference numeral 704a represents a first connection terminal that connects the second built-in antenna 202 to the RF module 206 when the antenna connector 704 is decoupled from the connector coupler 214, and reference numeral 704b represents a second connection terminal that is connected to the signal input terminal 214b to connect the external antenna 212 to the RF module 206 when the antenna connector 704 is coupled to the connector coupler 214.

Therefore, as shown in FIG. 8A, before the connector coupler 214 is coupled to the antenna connector 704, the second built-in antenna 202 is connected to the RF module 206 via the first connection terminal 704a and the baseband processor 706 detects detachment of the external antenna 212 by sensing a low-level signal being applied thereto through the pull-up/down resistor unit 702.

FIG. 8B illustrates circuit structures of the connector coupler 214 and the antenna connector 704 after they are coupled to each other. The signal input terminal 214b of the connector coupler 214 is coupled to the second connection terminal 704b of the antenna connector 704, decoupling from the first connection terminal 704a of the antenna connector 704.

Therefore, as shown in FIG. 8B, after the connector coupler 214 is coupled to the antenna connector 704, the external antenna 212 is connected to the RF module 206 via the second connection terminal 704b and the baseband processor 706 detects attachment of the external antenna 212 by sensing a high-level signal being applied thereto through the pull-up/down resistor unit 702.

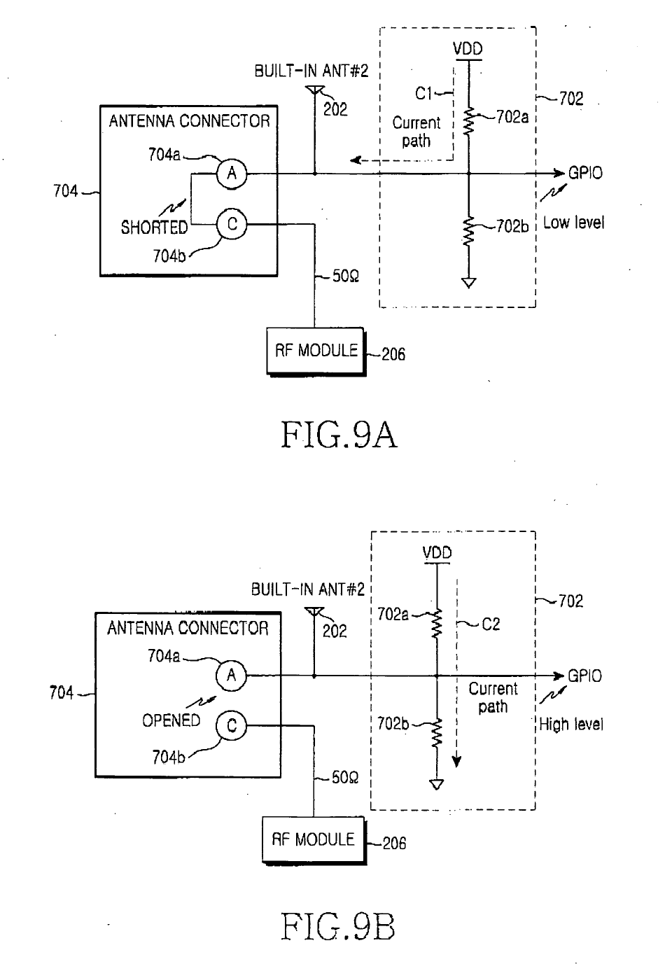

FIG. 9A is a diagram illustrating an exemplary structure of the pull-up/down resistor unit 702, given for a description of a voltage level being applied to the third input terminal GPIO before the antenna connector 704 is coupled to the connector coupler 214 as shown in FIG. 8A.

It will be assumed in FIGS. 9A and 9B that an impedance of a path between the RF module 206 and the antenna connector 704 is 50 Ω, a resistance of a first resistor 702a newly added according to the third embodiment of the present invention is sufficiently greater than the impedance between the RF module 206 and the antenna connector 704, and a second resistor 702b is sufficiently greater in resistance than the first resistor 702a. For example, in this embodiment, the first resistor 702a has a resistance of 1 KΩ, and the second resistor 702b has a resistance of 1 MΩ.

As shown in FIG. 9A, before the connector coupler 214 is coupled to the antenna connector 704, a current flows along a current path C1. Therefore, a low-level signal is input to the third input terminal GPIO and the baseband processor 706 detects detachment of the external antenna 212 in response to the low-level signal. Upon detecting the detachment of the external antenna 212, the baseband processor 706 optimizes the reception path for the broadcast signals to the first path.

FIG. 9B is a diagram illustrating an exemplary structure of the pull-up/down resistor unit 702, given for a description of a voltage level being applied to the third input terminal GPIO after the antenna connector 704 is coupled to the connector coupler 214 as shown in FIG. 8B.

As shown in FIG. 9B, after the connector coupler 214 is coupled to the antenna connector 704, a current flows along a current path C2. Therefore, a high-level signal is input to the third input terminal GPIO and the baseband processor 706 detects attachment of the external antenna 212 in response to the high-level signal. Upon detecting the attachment of the external antenna 212, the baseband processor 706 performs the process following step 410 of FIG. 4 and the process following step 608 of FIG. 6.

However, when the second built-in antenna 202 is directly connected to the first resistor 702a and the second resistor 702b in this manner, the broadcast signals received via the second built-in antenna 202 may suffer a loss. For example, a direct current (DC) component flows into a path between the RF module 206 and the antenna connector 704 from the power supply voltage Vdd and the broadcast signals, which are alternating current (AC) components, received from the second built-in antenna 202 flow into the first resistor 702a and the second resistor 702b, causing a loss of the broadcast signal.

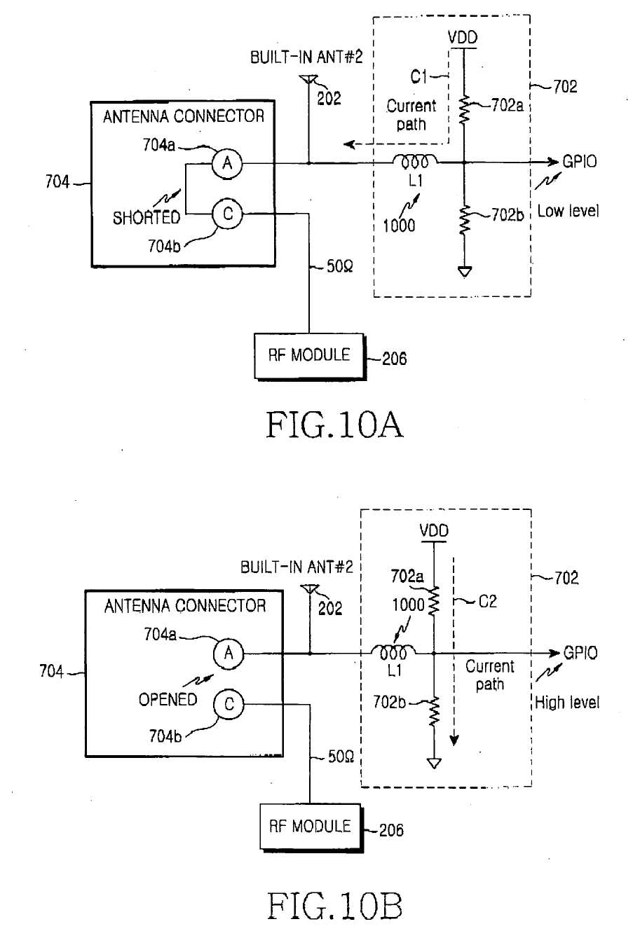

To solve the problems, the present invention proposes an alternative exemplary structure in which an inductor is provided between the second built-in antenna 202 and a contact of the first resistor 702a and the second resistor 702b as shown in FIGS. 10A and 10B.

FIG. 10A is a diagram illustrating an alternative exemplary structure of the pull-up/down resistor unit 702, given for a description of a voltage level being applied to the third input terminal GPIO before the antenna connector 704 is coupled to the connector coupler 214 as shown in FIG. 8A. FIG. 10B is a diagram illustrating an alternative exemplary structure of the pull-up/down resistor unit 702, given for a description of a voltage level being applied to the third input terminal GPIO after the antenna connector 704 is coupled to the connector coupler 214 as shown in FIG. 8B.

In the alternative exemplary structure shown in FIGS. 10A and 10B, an inductor L1 is interconnected between the second built-in antenna 202 and the contact of the first resistor 702a and the second resistor 702b, solving the signal loss problem. This is because an inductor has a characteristic of passing DC components and blocking AC components. It is assumed herein the inductor L1 has an inductance of 100 nH.

The use of the inductor L1 can prevent the signal loss occurring because the broadcast signals received through the second built-in antenna 202 flow into the pull-up/down resistor unit 702.

As can be understood from the foregoing description, the novel mobile terminal with a detachable external antenna for receiving satellite DMB signals can simply detect attachment and detachment of the external antenna, and optimize the broadcast signal reception path to the built-in antennas or the external antenna by detecting attachment and detachment of the external antenna, without separate key manipulation.

In addition, the novel apparatus and method automatically detects attachment and detachment of the external antenna, compares strength of received satellite DMB signals with a threshold, and provides a user with a message requesting for attachment of the external antenna or a message indicating an area where satellite DMB service is unavailable, according to the comparison result.

Furthermore, the proposed apparatus and method detects attachment/detachment of the external satellite antenna using a simple device regardless of a type of the antenna connector, contributing to a reduction in size and cost of the mobile terminal.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An external antenna detection apparatus in a mobile terminal for receiving a satellite digital multimedia broadcasting (DMB) service, comprising:
at least one built-in antenna for receiving a gap filler signal;
a detachable external antenna for receiving a satellite signal;
a radio frequency (RF) module for transmitting and receiving a radio signal;
an antenna connector for switching a reception path to one of a first path connected to the built-in antenna and a second path connected to the external antenna;
a connector coupler fixed to the external antenna, for selecting the reception path according to whether the connector coupler is coupled to the antenna connector; and
a baseband processor for processing a signal received through the first or second path via the RF module and detecting attachment and detachment of the external antenna according to a change in voltage-level signal caused by coupling and decoupling between the connector coupler and the antenna connector.

2. The external antenna detection apparatus of claim 1, wherein the built-in antenna includes a first built-in antenna and a second built-in antenna;
wherein in the antenna connector, a first terminal connected to the second built-in antenna is shorted to a second terminal connected to the RF module, when the antenna connector is decoupled from the connector coupler.

3. The external antenna detection apparatus of claim 2, wherein in the antenna connector, the first terminal connected to the second built-in antenna is disconnected from the second terminal connected to the RF module, when the antenna connector is coupled to the connector coupler.

4. The external antenna detection apparatus of claim 3, wherein the antenna connector switches the reception path to the first path for receiving the gap filler signal, when the antenna connector is decoupled from the connector coupler.

5. The external antenna detection apparatus of claim 3, wherein the antenna connector switches the reception path to the second path for receiving the satellite signal, when the antenna connector is coupled to the connector coupler.

6. The external antenna detection apparatus of claim 2, further comprising at least one pull-up resistor having one end connected to a power supply voltage and the other end connected to a contact between the baseband processor and the antenna connector, wherein the voltage-level signal becomes a high-level signal being applied through the pull-up resistor when the antenna connector is decoupled from the connector coupler.

7. The external antenna detection apparatus of claim 3, wherein the antenna connector further comprises an internal terminal, wherein when the connector coupler is coupled to the antenna connector, the internal terminal is connected to the ground of the mobile terminal and the voltage-level signal becomes a low-level signal.

8. The external antenna detection apparatus of claim 1, further comprising:
a display for displaying an operating state of the mobile terminal; and
a controller for, when a broadcast signal is received using the built-in antenna, comparing strength of the gap filler signal with a predetermined threshold, and outputting a message for requesting attachment of the external antenna to the display if the strength of the gap filler signal is less than or equal to the threshold.

9. The external antenna detection apparatus of claim 1, further comprising:
a display for displaying an operating state of the mobile terminal; and
a controller for, when a broadcast signal is received using the external antenna, comparing strength of the satellite signal with a predetermined threshold, and outputting a message indicating an area where the satellite DMB service is unavailable if the strength of the satellite signal is less than or equal to the threshold.

10. The external antenna detection apparatus of claim 1, further comprising a pull-up/down resistor unit having an end connected to a contact between the antenna connector and the built-in antenna and the other end connected to a third input terminal of the baseband processor.

11. The external antenna detection apparatus of claim 10, wherein when the antenna connector is coupled to the connector coupler, a high-level signal is applied to the third input terminal of the baseband processor via the pull-up/down resistor unit.

12. The external antenna detection apparatus of claim 10, wherein when the antenna connector is decoupled from the connector coupler, a low-level signal is applied to the third input terminal of the baseband processor via the pull-up/down resistor unit.

13. The external antenna detection apparatus of claim 10, wherein the pull-up/down resistor unit includes an inductor interconnected between the second built-in antenna and the third input terminal of the baseband processor.

14. The external antenna detection apparatus of claim 13, wherein the voltage-level signal becomes a high-level signal when the antenna connector is coupled to the connector coupler.

15. The external antenna detection apparatus of claim 13, wherein the voltage-level signal becomes a low-level signal when the antenna connector is decoupled from the connector coupler.

16. An external antenna detection method in a mobile terminal including at least one built-in antenna for receiving a gap filler signal from a gap filler for repeating a satellite signal transmitted from a digital multimedia broadcasting (DMB) satellite, a detachable external antenna for directly receiving the satellite signal, and a baseband processor for baseband signal processing, the method comprising the steps of:
determining by the baseband processor whether a connector coupler to which the external antenna is fixed is coupled to an antenna connector to which the built-in antenna is connected;
applying a predetermined voltage-level signal to the baseband processor if the connector coupler is coupled to the antenna connector; and
detecting, by the baseband processor, attachment of the external antenna based on the voltage-level signal.

17. The external antenna detection method of claim 16, wherein the antenna connector switches the reception path to a first path connected to the built-in antenna when the antenna connector is decoupled from the connector coupler.

18. The external antenna detection method of claim 16, wherein the antenna connector switches the reception path to a second path connected to the external antenna when the antenna connector is coupled to the connector coupler.

19. An external antenna detection method in a mobile terminal including at least one built-in antenna for receiving a gap filler signal from a gap filler for repeating a satellite signal transmitted from a digital multimedia broadcasting (DMB) satellite, and a detachable external antenna for directly receiving the satellite signal, the method comprising the steps of:
comparing strength of the gap filler signal with a predetermined threshold when a broadcast signal is received using the built-in antenna;
determining whether the external antenna is attached, if the strength of the gap filler signal is less than or equal to the threshold; and
outputting a message requesting attachment of the external antenna if the external antenna is detached.

20. The external antenna detection method of claim 19, further comprising the steps of:
comparing strength of the satellite signal with a predetermined threshold if a broadcast signal is received using the external antenna; and
outputting a message indicating an area where satellite DMB service is unavailable if the strength of the satellite signal is less than or equal to the threshold.
